(19) United States
(12) Patent Application Publication
(10) Pub. No.: US 2024/0287335 A1
(43) Pub. Date: Aug. 29, 2024

(54) Ink Jet Ink Composition, Recording Method, And Method For Manufacturing Ink Jet Ink Composition

(71) Applicant: SEIKO EPSON CORPORATION, Tokyo (JP)

(72) Inventors: Kenta KIKUCHI, Suwa (JP); Hiroaki KUMETA, Nagano (JP); Tetsuya AOYAMA, Shiojiri (JP)

(21) Appl. No.: 18/586,664

(22) Filed: Feb. 26, 2024

(30) Foreign Application Priority Data
Feb. 27, 2023 (JP) 2023-028858

(51) Int. Cl. C09D 11/326; C09D 11/037; C09D 11/14; C09D 11/328

(52) U.S. Cl. CPC C09D 11/326; C09D 11/037; C09D 11/14; C09D 11/328

(57) ABSTRACT

An aqueous ink jet ink composition contains a water-insoluble colorant, a lignosulfonate salt, and at least one element A selected from the group consisting of Ca, Mg, Mn, Fe, Al, and Si, and a total content of the element A is 5 to 120 mass ppm.

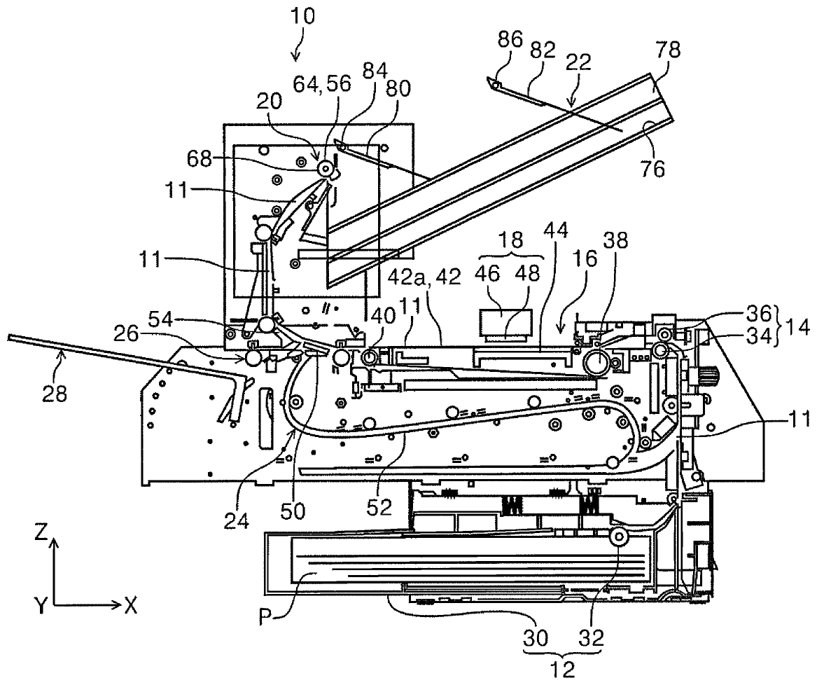

The present application is based on, and claims priority from JP Application Serial Number 2023-028858, filed Feb. 27, 2023, the disclosure of which is hereby incorporated by reference herein in its entirety.

### BACKGROUND

### 1. Technical Field

The present disclosure relates to an ink jet ink composition, a recording method, and a method for manufacturing an ink jet ink composition.

### 2. Related Art

Since being able to record a highly fine image by a relatively simple apparatus, an ink jet recording method has been rapidly developed in various fields. In particular, since environmental issues have been concerned in recent years, development of ink using a natural-derived material has been carried out in consideration of the environmental issues.

For example, JP-A-2022-167623 has disclosed an ink jet ink composition containing water, a vegetable-derived carbonized colorant, and a lignin resin.

In an ink composition, a water-insoluble colorant may be used in some cases. As the water-insoluble colorant, a natural-derived material may be used in some cases, and for example, vegetable charcoal, such as bamboo charcoal or wood charcoal, may be mentioned.

When those water-insoluble colorants are used for ink, redispersibility may become insufficient in some cases. In consideration of the point described above, there is still some room for improvement.

### SUMMARY

According to an aspect of the present disclosure, there is provided an aqueous ink jet ink composition comprising a water-insoluble colorant, a lignosulfonate salt, and at least one element A selected from the group consisting of Ca, Mg, Mn, Fe, Al, and Si. In the aqueous ink jet ink composition described above, a total content of the element A is 5 to 120 mass ppm.

According to another aspect of the present disclosure, there is provided a recording method comprising a step of ejecting the ink jet ink composition described above from an ink jet head so as to be adhered to a recording medium.

According to another aspect of the present disclosure, there is provided a method for manufacturing the ink jet ink composition described above, the method comprising a step of removing a complex obtained by mixing the lignosulfonate salt and a chelating agent.

### BRIEF DESCRIPTION OF THE DRAWINGS

FIG. is a view showing one example of a recording apparatus used in a recording method of this embodiment.

### DESCRIPTION OF EMBODIMENTS

Hereinafter, if needed, with reference to the drawing, although embodiments (hereinafter, each referred to as “this embodiment”) of the present disclosure will be described in detail, the present disclosure is not limited thereto and may be variously modified and/or changed without departing from the scope of the present disclosure. In addition, in the drawing, the same element is designated by the same reference numeral, and duplicated description is omitted. In addition, unless otherwise particularly noted, the top to bottom and the left to right positional relationships are based on the positional relationships shown in the drawing. Furthermore, the dimensional rate shown in the drawing is not limited to that shown therein.

### 1. Ink Jet Ink Composition

An ink jet ink composition (hereinafter, simply referred to as “ink composition” in some cases) of this embodiment is an aqueous ink jet ink composition and contains a water-insoluble colorant, a lignosulfonate salt, and at least one element A selected from the group consisting of Ca, Mg, Mn, Fe, Al, and Si. In the aqueous ink jet ink composition described above, a total content of the element A is 5 to 120 mass ppm.

The ink jet ink composition according to this embodiment uses a lignosulfonate salt as a dispersant for a water-insoluble colorant (such as a pigment). The lignosulfonate salt is a vegetable-derived salt and may contain at least one metal element as an impurity. Since the metal element may inhibit adsorption of the lignosulfonate salt to the colorant in some cases, a dispersion stability of the pigment may be degraded to cause generation of pigment aggregate, and as a result, foreign substances may be generated in some cases. In particular, when the ink is progressively dried, the foreign substances are solidified, the redispersibility is degraded, and an ejection property of the ink is unlikely to be recovered even when cleaning is performed.

In the ink jet ink composition according to this embodiment, since the content of the metal element is controlled at a predetermined amount or less, the redispersibility of the water-insoluble colorant is made excellent.

The control described above may be performed by metal refining. In particular, the control may be performed by metal refining using a chelating agent (in particular, EDTA).

Accordingly, since having the structure described above, the ink composition of this embodiment is excellent in redispersibility of the water-insoluble colorant.

In addition, since having the structure described above, the ink composition of this embodiment is also able to have an excellent sealing effect on the water-insoluble colorant.

A small amount of metal element is believed to contribute to the sealing effect on the water-insoluble colorant on a recording medium. Hence, since containing a predetermined amount or more of metal element, the ink jet ink composition according to this embodiment can suppress excessive permeation of the water-insoluble colorant on a recording medium, and as a result, a color development property is made excellent.

Although the reason for this has not been clearly understood, the following is considered.

A small amount of metal (or metal ion) in the ink is believed unlikely to contribute to the aggregation of the water-insoluble colorant. However, after the ink is adhered to a recording medium, since a solvent component of the ink is permeated and dried, and a solid content thereof is placed in a condensed state, even a small amount of metal contributes to the aggregation of the water-insoluble colorant. Hence, the excessive permeation of the water-insoluble colorant on the recording medium can be suppressed.

Hereinafter, components to be contained in the ink composition according to this embodiment, physical properties thereof, and a method for manufacturing the ink composition will be described.

### 1.1. Water-Insoluble Colorant

The ink composition contains a water-insoluble colorant. As the water-insoluble colorant, a natural-derived colorant is preferably contained. The ink composition may contain a colorant other than the water-insoluble colorant. The water-insoluble colorant may be used alone, or at least two types thereof may be used in combination.

The natural-derived colorant is not particularly limited, and for example, Bincho charcoal, bamboo charcoal, activated charcoal, white charcoal, black charcoal, extruded charcoal, sawdust briquette charcoal, plum charcoal, oak charcoal, Oregon pine charcoal, seaweed charcoal, mangrove charcoal, coconut shell charcoal, or vegetable oil-based carbon black may be used.

In addition, the water-insoluble colorant may contain an inorganic pigment including a carbon black (C.I. Pigment Black 7), such as a furnace black, a lamp black, an acetylene black, or a channel black, an iron oxide, or a titanium oxide; an organic pigment, such as a quinacridone-based pigment, a quinacridonequinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, or an azo-based pigment; or a disperse dye, such as C.I. Disperse Yellow, C.I. Disperse Red, C.I. Disperse Blue, C.I. Disperse Orange, C.I. Disperse Violet, or C.I. Disperse Black.

A content of the water-insoluble colorant is not particularly limited, and for example, the content described above with respect to a total mass of the ink composition may be 1.0 to 30 percent by mass. In order to further improve a storage stability of the ink composition, the content of the water-insoluble colorant with respect to the total mass of the ink composition is preferably 2.0 to 20 percent by mass, more preferably 3.0 to 15 percent by mass, and further preferably 4.0 to 10 percent by mass.

As the water-insoluble colorant, a refined water-insoluble colorant may also be used. In the case of a non-natural derived colorant, for example, a small amount of metal element may be inevitably mixed therein in its production process. In addition, in the case of a natural-derived colorant, for example, since metal (mineral) components necessary for the growth of vegetable are contained therein, various metal elements may also be contained in a vegetable charcoal-derived colorant. When a water-insoluble colorant obtained by removing those metal elements by refining or the like is used, the element A which will be described later can be controlled in a predetermined range.

As long as a method capable of controlling the amount of metal components in the water-insoluble colorant is used, a method to refine the water-insoluble colorant is not particularly limited. For example, there may be mentioned a method to remove a metal complex formed using a chelating agent or a method to remove a metal salt by dissolution thereof using an acid.

For example, as one method, the case may be mentioned in which, to 100 g of vegetable charcoal functioning as a water-insoluble colorant, approximately 0.6 g of a sodium hydroxide, approximately 3.0 g of a chelating agent (such as disodium ethylenediaminetetraacetate), and water as the balance are added to prepare a solution having a mass of approximately 700 g as a whole. While being stirred, the solution thus obtained was heated at approximately 90° C. for approximately 4 hours. Subsequently, after the solution is cooled to ordinary temperature, centrifugal separation is performed, so that the vegetable charcoal is recovered. The vegetable charcoal is mixed and stirred with pure water and then further processed by centrifugal separation, and this operation is repeatedly performed. A finally recovered material is dried by a dryer, so that refined vegetable charcoal is obtained.

In addition, when the types of chemical reagents described above, the mass ratio therebetween, the heating temperature, the heating time, and the like are adjusted, the mass of the metal component in the refined vegetable charcoal-derived colorant can be appropriately controlled.

### 1.2. Lignosulfonate Salt

The ink composition of this embodiment contains a lignosulfonate salt. The lignosulfonate salt may be contained as a dispersant.

Since the ink composition contains a lignosulfonate salt, the water-insoluble colorant is stably dispersed in the ink composition, and the ejection stability of the ink composition can be improved thereby. Although the factors thereof have not been clearly understood, the lignosulfonate salt is likely to trap a polyvalent metal ion to form a complex. Hence, after the metal components and a plurality of lignosulfonate salts in the ink composition are bonded to each other, the lignosulfonate salts stably cover the surface of the vegetable charcoal, and as a result, it is believed that the dispersion stability can be further improved, and the storage stability is also improved. Accordingly, the lignosulfonate salt is believed to form a complex with the metal component in the ink composition.

The lignosulfonate salt may also be used for dispersion of a related carbon black, disperse dye, or the like, and for example, even when the lignosulfonate salt is used for a vegetable charcoal pigment which is not likely to be dispersed, an excellent dispersion stability thereof can be obtained. In the case described above, since the metal concentration is decreased, excellent dispersion stability, foreign substance resistance, and redispersibility can be obtained.

The lignosulfonate salt is not particularly limited as long as being a lignin or a lignin decomposed material and having at least one sulfonic group, and the lignosulfonate salt and its derivative are included. The lignosulfonate salt is not particularly limited, and for example, there may be mentioned a ligninsulfonic acid alkali metal salt, such as a sodium, a lithium, or a potassium lignosulfonate, or an ammonium lignosulfonate. In addition, the lignosulfonate salt may be used alone, or at least two types thereof may be used in combination.

A weight average molecular weight of the lignosulfonate salt may be, for example, 1,000 to 80,000. In order to further improve the redispersibility of the water-insoluble colorant of the ink composition and/or the ejection stability thereof, the weight average molecular weight of the lignosulfonate salt is preferably 2,000 to 50,000, more preferably 3,000 to 40,000, even more preferably 4,000 to 35,000, and further preferably 5,000 to 30,000.

The lignosulfonate salt is vegetable derived and may contain at least one metal element as an impurity.

As the lignosulfonate salt, a refined lignosulfonate salt obtained by removing metal elements is preferably contained, and a refined lignosulfonate salt refined using a chelating agent is more preferably contained. A refining method using a chelating agent is not particularly limited, and for example, a method in which after a lignosulfonate salt and a chelating agent are mixed together, a complex obtained thereby is removed may be mentioned. Since a refined lignosulfonate salt having a high purity is used, the content of the element A in the ink composition can be more easily controlled in the range which will be described below.

The lignosulfonate salt and the chelating agent may be mixed in an aqueous solution. In addition, the aqueous solution used for a complex separation treatment is a solution using water as a primary solvent, and if needed, a water-soluble organic solvent may also be added thereto, and/or another component, such as a base or an acid, may also be added. For example, in accordance with the type of chelating agent, a base or an acid to adjust the pH may be added in the aqueous solution. As one example, in order to improve a treatment efficiency, the treatment described above may be performed under basic conditions, and for example, a NaOH aqueous solution may be used.

A mixing temperature between the lignosulfonate salt and the chelating agent is preferably 20° C. to 100° C., more preferably 40° C. to 95° C., and further preferably 60° C. to 95° C. In addition, a mixing time therebetween is preferably 1 to 12 hours, more preferably 2 to 10 hours, and further preferably 3 to 8 hours.

Although a method to remove the complex from a mixture solution of the lignosulfonate salt and the chelating agent is not particularly limited, for example, a known solid-liquid separation method, such as filtration or centrifugal separation, may be used. In the case described above, the lignosulfonate salt processed by the complex separation treatment is separated in the form of a solid, and the complex may be separated in the state of being dissolved in a liquid. In addition, after being separated, the lignosulfonate salt processed by the complex separation treatment may be washed with pure water or the like at least one time. In addition, when a base or an acid is added, in the washing, a neutralization treatment may also be performed.

In the complex separation treatment, the mixing between the lignosulfonate salt and the chelating agent and the removal of the complex thus obtained are regarded as one cycle, and the treatment may be performed at least one cycle.

In addition, when the types of the chemical reagents used in the refining, the mass ratio therebetween, the heating temperature, the heating time, the number of cycles, and the like are adjusted, the amount of the metal element in the refined lignosulfonate salt can be appropriately controlled.

For example, depending on the number of refining operations, the metal concentration can be adjusted. In addition, when the type of chelating agent, the pore diameter of an ultrafiltration membrane filter, and the like are appropriately changed, the concentration of each metal species can be controlled. For example, when a divalent metal chelating agent is used, a complex obtained from iron is increased in size and is removed by an ultrafiltration membrane, and as a result, the concentration thereof is decreased; however, when an ultrafiltration membrane having a large pore diameter is used, the complex can be made unlikely to be removed.

The chelating agent is not particularly limited, and for example, there may be mentioned an aminocarboxylic acid-based chelating agent, such as ethylenediaminetetraacetic acid (EDTA), an edetate disalt, nitrilotriacetic acid (NTA), methylglycine diacetic acid (MGDA), diethylenetriaminepentaacetic acid (DTPA), hydroxyethylethylenediaminetriacetic acid (HEDTA), triethylenetetraminehexaacetic acid (TTHA), glutamic acid diacetic acid (GLDA), hydroxyethyliminodiacetic acid (HIDA), dihydroxyethylglycine (DHEG), 1,3-propanediaminetetraacetic acid (PDTA), 1,3-diamino-2-hydroxypropanehexaacetic acid (DPTA-OH), aspartic acid diacetic acid (ASDA), or ethylenediamine succinic acid (EDDS); a phosphonic acid-based chelating agent, such as a pyrophosphate salt, 1-hydroxyethylidene-1,1-diphosphonic acid (HEDP), nitrilotrimethylenephosphonic acid (NTMP), phosphonobutanetricarboxylic acid (PBTC), or ethylenediaminetetramethylenephosphonic acid (EDTMP); a phosphoric acid-based chelating agent, such as a hexametaphosphoric acid salt or tripolyphosphoric acid; or a hydroxycarbonate-based chelating agent, such as citric acid, tartaric acid, or gluconic acid. In addition, the chelating agent may be used alone, or at least two types thereof may be used in combination.

Among those mentioned above, the aminocarboxylic acid-based chelating agent is preferable, and ethylenediaminetetraacetic acid (EDTA) is more preferable. Since the chelating agent as described above is used, a removal property of a water-soluble salt and an ion contained in the lignosulfonate salt, and the foreign substance resistance and the ejection stability tend to be further improved.

The lignosulfonate salt and its derivative are not particularly limited, and for example, as a commercial product name, for example, there may be mentioned Pearllex NP (manufactured by Nippon Paper Industries Co., Ltd.), Pearllex DP (manufactured by Nippon Paper Industries Co., Ltd.), Vanilex N (manufactured by Nippon Paper Industries Co., Ltd.), 471038-100G (manufactured by Sigma-Aldrich), Newkalgen WG-4 (manufactured by Takemoto Oil & Fat Co., Ltd.), or SAN X P252 (manufactured by Nippon Paper Industries Co., Ltd.). In order to further improve the effect of the ink composition of the present disclosure, as the lignosulfonate salt, Pearllex NP, Vanilex N, Pearllex DP, 471038-100G, Newkalgen WG-4, or SAN X P252 is preferable, and Pearllex NP, Vanilex N, Pearllex DP, 471038-100G, or Newkalgen WG-4 is more preferable.

A ratio (C/B) of a content (C) of the lignosulfonate salt to a content (B) of the water-insoluble colorant is not particularly limited, and for example, the ratio described above may be 0.2 to 4.2. In order to improve the ejection stability of the ink composition, the content ratio (C/B) described above is preferably 0.3 to 3.5, more preferably 0.5 to 3.0, even more preferably 0.7 to 2.5, and further preferably 1.0 to 2.0.

The content of the lignosulfonate salt is not particularly limited, and for example, the content described above with respect to the total mass of the ink composition may be 0.1 to 40 percent by mass. In order to more efficiently and reliably obtain the effect of the present disclosure, the content of the lignosulfonate salt with respect to the total mass of the ink composition is preferably 0.3 to 35 percent by mass, more preferably 0.5 to 30 percent by mass, even more preferably 1.0 to 25 percent by mass, and further preferably 3.0 to 18 percent by mass.

### 1.3. Element A

The ink composition may contain at least one element A selected from the group consisting of Ca, Mg, Mn, Fe, Al, and Si.

The element A may be present in the form of a metal compound, a metal ion, or a single metal element. Among those mentioned above, the element A is preferably present in the form of a water-soluble metal salt, a metal ion, or the like. In addition, the element A contained in the ink composition may be derived from the water-insoluble colorant or the lignosulfonate salt or may also be an element added in a step of preparing the ink composition.

A total content of the element A with respect to the total mass of the ink composition is 5 to 120 mass ppm. When the total content of the element A is 120 mass ppm or less, the redispersibility of the water-insoluble colorant is made excellent, and a clogging recovery property can be further improved. From the same point as described above, the total content of the element A described above is preferably 120 mass ppm or less, more preferably 110 mass ppm or less, and further preferably 100 mass ppm or less.

Since the total content of the element A described above is 5 mass ppm or more, the sealing effect on the water-insoluble colorant is made excellent, and the color development property of a recorded matter to be obtained is more improved. From the same point as described above, the total content of the element A described above is preferably 10 mass ppm or more and more preferably 15 mass ppm or more.

A method to measure the mass of the metal element in the ink composition is not particularly limited, and for example, an inductively coupled plasma optical emission spectrometry (ICP-OES) or an inductively coupled plasma mass spectrometry (ICP-MS) may be mentioned. In the ink composition of this embodiment, an inductively coupled plasma optical emission spectrometry (ICP-OES) is preferable.

According to the knowledge of the present inventor, as the valency of the metal, a monovalent metal is relatively unlikely to cause aggregation of the water-insoluble colorant and generation of foreign substances, and on the other hand, at least divalent metal is relatively likely to cause aggregation of the water-insoluble colorant and generation of foreign substances. Hence, for example, a content of at least trivalent metal is preferably decreased.

The divalent metal is excellent not only in sealing effect but also in color development property and granularity and is not likely to cause aggregation and generation of foreign substances. Hence, the divalent metal is preferably contained in a predetermined amount.

In consideration of the redispersibility of the water-insoluble colorant and the sealing effect thereon, in the ink composition, a total content of Ca and Mg is preferably 4 to 100 mass ppm, more preferably 10 to 95 mass ppm, and further preferably 40 to 90 mass ppm.

In consideration of the redispersibility of the water-insoluble colorant and the sealing effect thereon, in the ink composition, a total content of Mn and Fe is preferably 1 to 50 mass ppm, more preferably 3 to 40 mass ppm, and further preferably 5 to 30 mass ppm.

In consideration of the redispersibility of the water-insoluble colorant and the sealing effect thereon, in the ink composition, a total content of Al and Si is preferably 25 mass ppm or less, more preferably 15 mass ppm or less, and further preferably 5 mass ppm or less.

The total content of Al and Si may also be 0 mass ppm or more, more than 0 mass ppm, and 0.1 mass ppm or more.

The ink composition may also contain other elements other than the element A.

As the other elements, for example, P, S, Cl, K, Na, Cr, Ti, Ni, and/or Cu may be mentioned.

### 1.4. Water

The ink composition of this embodiment is an aqueous ink composition containing water. The aqueous ink composition is an ink composition at least containing water as a primary solvent component of the ink.

A content of the water with respect to the total mass of the ink is preferably 30 to 90 percent by mass, more preferably 40 to 85 percent by mass, and further preferably 50 to 80 percent by mass.

Since the content of the water is not less than the lower value described above, even when the water is partially evaporated, an increase in viscosity of the ink is suppressed, and a sedimentation property tends to be suppressed. In addition, since the content of the water is not higher than the upper value described above, curling tends to be further suppressed.

### 1.5. Water-Soluble Organic Solvent

The ink composition of this embodiment contains a water-soluble organic solvent. Since the ink composition contains a water-soluble organic solvent, the storage stability tends to be further improved. In addition, the water-soluble organic solvent may be used alone, or at least two types thereof may be used in combination.

The water-soluble organic solvent is not particularly limited, and for example, there may be mentioned glycerin, N-methyl pyrrolidone, ethylene glycol, diethylene glycol, triethylene glycol, propylene glycol, dipropylene glycol, tripropylene glycol, propanediol, butanediol, pentanediol, or hexylene glycol. Among those mentioned above, in view of a moisture retaining effect, glycerin is preferable. In addition, the water-soluble organic solvent may be used alone, or at least two types thereof may be used in combination.

A content of the water-soluble organic solvent is not particularly limited, and for example, the content described above with respect to the total mass of the ink composition is 1.0 to 50 percent by mass. In order to more efficiently and reliably obtain the effect of the present disclosure, the content of the water-soluble organic solvent with respect to the total mass of the ink composition is preferably 3.0 to 40 percent by mass, more preferably 5.0 to 30 percent by mass, and further preferably 8.0 to 20 percent by mass.

### 1.6. Surface Tension Adjuster

The ink composition of this embodiment preferably contains a surface tension adjuster (hereinafter, to be used as the same meaning as “surfactant”). The surface tension adjuster is not particularly limited, and for example, an acetylene glycol-based surfactant, a fluorine-based surfactant, or a silicone-based surfactant may be mentioned. Among those mentioned above, in view of the storage stability of the ink composition, an acetylene glycol-based surfactant is preferable. In addition, the surface tension adjuster may be used alone, or at least two types thereof may be used in combination.

The acetylene glycol-based surfactant is not particularly limited, and for example, at least one selected from the group consisting of 2,4,7,9-tetramethyl-5-decyne-4,7-diol, an alkylene oxide adduct thereof, 2,4-dimethyl-5-decyne-4-ol, and an alkylene oxide adduct thereof is preferable. A commercial product of the acetylene glycol-based surfactant is not particularly limited, and for example, there may be mentioned Olfine 104 Series or E Series such as Olfine E1010 (trade name, manufactured by Air Products and Chemicals Inc.), or Surfynol 61, 104, or 465 (trade name, manufactured by Nisshin Chemical Industry Co., Ltd.). Among those mentioned above, in order to more efficiently and reliably obtain the effect of the present disclosure, as the surface tension adjuster, Olfine E1010 is preferably contained.

A content of the surface tension adjuster is not particularly limited, and for example, the content described above with respect to the total mass of the ink composition is 0.01 to 5.0 percent by mass. The content of the surface tension adjuster with respect to the total mass of the ink composition is preferably 0.05 to 3.0 percent by mass and more preferably 0.1 to 1.0 percent by mass.

### 1.7. Method for Manufacturing Ink Jet Ink Composition

A method for manufacturing an ink jet ink composition of this embodiment is not particularly limited, and a method in which a water-insoluble colorant, a lignosulfonate salt, and at least one element A selected from the group consisting of Ca, Mg, Mn, Fe, Al, and Si are mixed together may be mentioned.

The method for manufacturing an ink jet ink composition of this embodiment preferably includes a step of removing a complex obtained by mixing a lignosulfonate salt and a chelating agent. Accordingly, a refined lignosulfonate salt refined using the chelating agent can be obtained.

### 2. Recording Method

A recording method of this embodiment includes an ejection step of ejecting the ink jet ink composition of this embodiment from an ink jet head so as to be adhered to a recording medium.

An ink jet method according to this embodiment may further include a transport step of transporting a recording medium. In addition, the ejection step and the transport step may be simultaneously or alternately performed.

### 2.1. Ejection Step

In the ejection step, the ink is ejected from the ink jet head and is adhered to the recording medium. In more particular, a pressure generation device provided in the ink jet head is driven, and the ink filled in a pressure generation chamber of the ink jet head is ejected from a nozzle. The ejection method as described above is also called an ink jet method.

As the ink jet head used in the ejection step, a line head to perform recording by a line method and a serial head to perform recording by a serial method may be mentioned.

In the line method using a line head, for example, an ink jet head having a width equal to or larger than a recording width of a recording medium is fixed in a recording apparatus. In addition, the recording medium is transferred in a sub-scanning direction (transport direction of the recording medium), and in conjunction with this transfer, ink droplets are ejected from the ink jet head, so that an image is recorded on the recording medium.

In the serial method using a serial head, for example, an ink jet head is mounted on a carriage which can be transferred in a width direction of a recording medium. In addition, the carriage is transferred in a main scanning direction (width direction of the recording medium), and in conjunction with this transfer, ink droplets are ejected from the ink jet head, so that an image is recorded on the recording medium.

### 2.2. Transport Step

In the transport step, the recording medium is transported in a predetermined direction in the recording apparatus. In more particular, using a transport roller and/or a transport belt provided in the recording apparatus, the recording medium is transported from a paper supply portion to a paper discharge portion in the recording apparatus. In this transport step, the ink ejected from the ink jet head is adhered to the recording medium, so that a recorded matter is formed. The transport may be performed continuously or intermittently.

### 2.3. Recording Medium

A recording medium used in this embodiment is not particularly limited, and for example, an absorbing or a non-absorbing recording medium may be mentioned.

The absorbing recording medium is not particularly limited, and for example, there may be mentioned media from regular paper, such as electrophotographic paper, having a high ink permeability and ink jet paper (ink jet exclusive paper including an ink absorbing layer formed from silica particles or alumina particles or an ink absorbing layer formed of a hydrophilic polymer, such as a poly(vinyl alcohol) (PVA) or a poly(vinyl pyrrolidone) (PVP)) to art paper, coated paper, and cast paper each of which has a relatively low ink permeability and is used for general offset printing.

Although the non-absorbing recording medium is not particularly limited, for example, there may be mentioned a film or a plate formed from a plastic, such as a poly(vinyl chloride), a polyethylene, a polypropylene, a poly(ethylene terephthalate) (PET), a polycarbonate, a polystyrene, or a polyurethane; a plate formed from a metal, such as iron, silver, copper, or aluminum; a metal plate or a plastic-made film manufactured by deposition of at least one of the various metals mentioned above; a plate formed from an alloy, such as stainless steel or brass; or a recording medium in which a film of a plastic, such as a poly(vinyl chloride), a polyethylene, a polypropylene, a poly(ethylene terephthalate) (PET), a polycarbonate, a polystyrene, or a polyurethane, is adhered (coated) to a paper-made substrate.

### 3. Recording Apparatus

A recording apparatus of this embodiment includes an ink jet head having at least one nozzle to eject an ink jet ink composition to a recording medium and a transport device to transport the recording medium. The ink jet head includes a pressure chamber to which the ink is supplied and the nozzle to eject the ink. In addition, the transport device is formed from a transport roller and/or a transport belt provided in the recording apparatus.

Hereinafter, the recording apparatus according to this embodiment will be described with reference to FIGURE. In addition, in the X-Y-Z coordinate system shown in FIGURE, an X direction indicates a length direction of the recording medium, a Y direction indicates a width direction of the recording medium in a transport path in the recording apparatus, and a Z direction indicates a height direction of the apparatus.

As one example of a recording apparatus 10, a line type ink jet printer capable of performing printing at a high speed and at a high density will be described. The recording apparatus 10 includes a feed portion 12 to store a recording medium P such as paper, a transport portion 14, a belt transport portion 16, a record portion 18, an Fd (facedown) discharge portion 20 functioning as a “discharge portion”, an Fd (facedown) stage 22 functioning as a “stage”, a reverse path portion 24 functioning as a “reverse transport mechanism”, an Fu (faceup) discharge portion 26, and an Fu (faceup) stage 28.

The feed portion 12 is disposed at a lower side of the recording apparatus 10. The feed portion 12 includes a feed tray 30 to store the recording medium P and a feed roller 32 to feed the recording medium P stored in the feed tray 30 to a transport path 11.

The recording medium P stored in the feed tray 30 is fed to the transport portion 14 along the transport path 11 by the feed roller 32. The transport portion 14 includes a transport drive roller 34 and a transport driven roller 36. The transport drive roller 34 is rotationally driven by a driving source not shown. In the transport portion 14, the recording medium P is nipped between the transport drive roller 34 and the transport driven roller 36 and is then transported to the belt transport portion 16 located downstream of the transport path 11.

The belt transport portion 16 includes a first roller 38 located upstream of the transport path 11, a second roller 40 located downstream thereof, an endless belt 42 fitted to the first roller 38 and the second roller 40 in a rotationally transferable manner, and a support body 44 to support an upper-side section 42a of the endless belt 42 between the first roller 38 and the second roller 40.

The endless belt 42 is driven by the first roller 38 or the second roller 40 driven by a driving source not shown so as to be transferred from a +X direction to a −X direction in the upper-side section 42a. Hence, the recording medium P transported from the transport portion 14 is further transported downstream of the transport path 11 in the belt transport portion 16.

The record portion 18 includes a line type ink jet head 48 and a head holder 46 to hold the ink jet head 48. In addition, the record portion 18 may also be a serial type in which an ink jet head is mounted on a carriage which is reciprocally transferred in a Y axis direction. The ink jet head 48 is disposed so as to face the upper-side section 42a of the endless belt 42 supported by the support body 44. When the recording medium P is transported in the upper-side section 42a of the endless belt 42, the ink jet head 48 ejects the ink to the recording medium P, so that the recording is carried out. While the recording is carried out, the recording medium P is transported downstream of the transport path 11 by the belt transport portion 16.

In addition, the “line type ink jet head” is a head used for the recording apparatus in which a nozzle region formed in a direction intersecting the transport direction of the recording medium P is provided so as to cover the entire recording medium P in the intersecting direction, and while one of the head and the recording medium P is fixed, the other is transferred to form an image. In addition, the nozzle region of the line head in the intersecting direction may not be always required to cover the entire region in the intersecting direction of every type of recording medium P that can be applied to the recording apparatus.

In addition, a first branch portion 50 is provided downstream of the transport path 11 of the belt transport portion 16. The first branch portion 50 is configured to switchably communicate with one of the transport path 11 to transport the recording medium P to the Fd discharge portion 20 or the Fu discharge portion 26 and a reverse path 52 of the reverse path portion 24 in which after a recording surface of the recording medium P is reversed, the recording medium P is again transported to the record portion 18. In addition, the recording medium P to be transported after the transport path 11 is switched to the reverse path 52 by the first branch portion 50 is processed such that the recording surface thereof is reversed in a transport process in the reverse path 52 and is again transported to the record portion 18 so that a surface of the recording medium P opposite to the original recording surface faces the ink jet head 48.

In addition, a second branch portion 54 is further provided downstream of the first branch portion 50 along the transport path 11. The second branch portion 54 is configured so as to transport the recording medium P to one of the Fd discharge portion 20 and the Fu discharge portion 26 by switching the transport direction of the recording medium P.

The recording medium P transported to the Fd discharge portion 20 by the second branch portion 54 is discharged from the Fd discharge portion 20 and then placed on the Fd stage 22. In this case, the recording surface of the recording medium P is placed so as to face the Fd stage 22. In addition, the recording medium P transported to the Fu discharge portion 26 by the second branch portion 54 is discharged from the Fu discharge portion 26 and then placed on the Fu stage 28. In this case, the recording surface of the recording medium P is placed so as to face a side opposite to the Fu stage 28.

In addition, although the case in which the line type ink jet head is used has been described above by way of example, the recording apparatus of this embodiment may be a printer (serial printer) using a serial type ink jet head. In the serial printer, while a recording medium is transported in a transport direction, the ink jet head is transferred in a direction intersecting the transport direction described above, so that the printing is performed.

### 4. Recorded Matter

A recorded matter of this embodiment is obtained by adhering the ink composition to a recording medium. Since the ink composition described above is excellent in redispersibility and ejection stability, even when repetitive recording is performed, recorded matters can be stably obtained.

### EXAMPLES

Hereinafter, the present disclosure will be described in more detail with reference to Examples and Comparative Examples. The present disclosure is not at all limited to the following Examples.

### 1. Preparation of Ink Composition

In order to have one of the compositions shown in Tables 1 to 3, after components were charged in a mixing tank and then mixed and stirred, filtration was further performed using a membrane filter, so that an ink jet ink composition of each Example was obtained.

In addition, unless otherwise particularly noted, the numerical value of each component of each Example shown in the table is on a percent by mass basis. In addition, in the table, the numerical value of the colorant represents percent by mass of a solid content.

The abbreviations and details of the product components in Tables 1 to 3 are as shown below. In addition, the high purity refined product indicates a refined compound.

### Water-Insoluble Colorant

Bincho charcoal (manufactured by Kiriya Chemical Co., Ltd.)
carbon black (vegetable oil-base, manufactured by Orion Engineered Carbons)
Dispers Red 60 (manufactured by Dystar) Water-Soluble Colorant
Solvent Red 135 (manufactured by Career Henan Chemical) Lignosulfonate Salt
Pearllex NP (high purity refined product, manufactured by Nippon Paper Industries Co., Ltd.)
Vanilex N (high purity refined product, manufactured by Nippon Paper Industries Co., Ltd.)
Pearllex DP (high purity refined product, manufactured by Nippon Paper Industries Co., Ltd.)

The sodium lignosulfonate salts described above are each a refined sodium lignosulfonate refined by removing a complex obtained by mixing a lignosulfonate salt and EDTA (chelating agent).

### Naphthalene Sulfonate Salt

sodium naphthalene sulfonate (Demol SSL, manufactured by Kao Corporation)

### Solvent (Water-Soluble Organic Solvent)

propylene glycol (commercial product)
glycerin (commercial product)

### Surface Tension Adjuster

Olfine E1010 (manufactured by Nisshin Chemical Industry Co., Ltd.)

### 3. Measurement Method

### 3.1. Mass Analysis of Metal Component

The mass analysis of each metal element in the ink was performed using an ICP-OES (G8015AA, manufactured by Agilent Technologies).

### 4. Evaluation Method

### 4.1. Clogging Recovery Property

The ink compositions were each filled in a predetermined ink container, and this container was fitted to a PX-H6000 manufactured by Seiko Epson Corporation. After all nozzles were confirmed to perform normal ejection, the recording apparatus in a normal state was powered off and was then left in an environment at 40° C. for one month. Subsequently, a recovery operation was performed by suction, and the number of recovery operations required for the normal ejection was obtained and then evaluated in accordance with the following criteria. B or higher was regarded as a preferable level.

### Evaluation Criteria

AA: normal ejection is performed immediately after power is on or after recovery operation is performed 1 to 3 times.
A: normal ejection is performed after recovery operation is performed 4 to 6 times.
B: normal ejection is performed after recovery operation is performed 7 to 9 times.
C: normal ejection is not performed even when recovery operation is performed 9 times.

### 4.2. Color Development Property (Od Value)

The ink composition was set in a printer (PX-S840, manufactured by Seiko PMC Corporation), and solid printing at a duty of 100% was performed on A4-size paper. After the printing was performed on regular paper, the OD of a printed matter thus obtained was evaluated in accordance with the following criteria. B or higher was regarded as a preferable level.

### Evaluation Criteria

AA: OD value is 1.0 or more.
A: OD value is 0.8 to less than 1.0.
B: OD value is 0.6 to less than 0.8.
C: OD value is less than 0.6.

TABLE 1

| | | Example | Example | Example | Example | Example |
|---|---|---|---|---|---|---|
| | | 1 | 2 | 3 | 4 | 5 |
| Water-Insoluble | Bincho Charcoal (Pigment) | 6 | 6 | 6 | 6 | 6 |
| Colorant | Carbon Black (Pigment) | — | — | — | — | — |
| | Dispers Red 60 (Disperse Dye) | — | — | — | — | — |
| Water-Soluble | Solvent Red 135 (Dye) | — | — | — | — | — |
| Colorant | | | | | | |
| Lignosulfonate | Sodium Lignosulfonate | 9 | 9 | 9 | 9 | 9 |
| Salt | Pearllex NP (Nippon Paper | | | | | |
| | Industries Co., Ltd.) | | | | | |
| | Mw = 30000 | | | | | |
| | Sodium Lignosulfonate | — | — | — | — | — |
| | Vanilex N (Nippon Paper | | | | | |
| | Industries Co., Ltd.) | | | | | |
| | Mw = 5000 | | | | | |
| | Sodium Lignosulfonate | — | — | — | — | — |
| | Pearllex DP (Nippon Paper | | | | | |
| | Industries Co., Ltd.) | | | | | |
| | Mw = 10000 | | | | | |
| Naphthalene | Sodium Naphthalene Sulfonate | — | — | — | — | — |
| Sulfonate Salt | Demol SSL (Kao Corporation) | | | | | |
| Metal Element | Total Metal (ppm) | 100 | 50 | 5 | 100 | 15 |
| | Ca (ppm) | — | — | — | 10 | 2.5 |
| | Mg (ppm) | 90 | 40 | 4 | 80 | 2.5 |
| | Mn (ppm) | — | — | — | — | — |
| | Fe (ppm) | 5 | 5 | 1 | 5 | 5 |
| | Al (ppm) | — | — | — | — | — |
| | Si (ppm) | 5 | 5 | 0 | 5 | 5 |
| Solvent | Propylene Glycol | 8 | 8 | 8 | 8 | 8 |
| | Glycerin | 8 | 8 | 8 | 8 | 8 |
| Surface Tension | Olfine E1010 | 0.1 | 0.1 | 0.1 | 0.1 | 0.1 |
| Adjuster | | | | | | |
| Water | Pure Water | Balance | Balance | Balance | Balance | Balance |
| Ca, Mg | Alkaline Earth Metal (ppm) | 90 | 40 | 4 | 90 | 5 |
| Mn, Fe | Transition Metal (ppm) | 5 | 5 | 1 | 5 | 5 |
| Al, Si | Typical Element (ppm) | 5 | 5 | 0 | 5 | 5 |
| Evaluation | Clogging Recovery Property | B | AA | AA | B | AA |
| | Color Development Property (OD) | AA | AA | A | AA | A |

TABLE 2

| | | Example | Example | Example | Example | Example | Example |
|---|---|---|---|---|---|---|---|
| | | 6 | 7 | 8 | 9 | 10 | 11 |
| Water- | Bincho Charcoal (Pigment) | 6 | 6 | 6 | 6 | — | — |
| Insoluble | Carbon Black (Pigment) | — | — | — | — | 6 | — |
| Colorant | Dispers Red 60 (Disperse Dye) | — | — | — | — | — | 5 |
| Water-Soluble | Solvent Red 135 (Dye) | — | — | — | — | — | — |
| Colorant | | | | | | | |
| Lignosulfonate | Sodium Lignosulfonate | 9 | 9 | 9 | 9 | — | — |
| Salt | Pearllex NP (Nippon Paper | | | | | | |
| | Industries Co., Ltd.) | | | | | | |
| | Mw = 30000 | | | | | | |
| | Sodium Lignosulfonate | — | — | — | — | — | 9 |
| | Vanilex N (Nippon Paper | | | | | | |
| | Industries Co., Ltd.) | | | | | | |
| | Mw = 5000 | | | | | | |
| | Sodium Lignosulfonate | — | — | — | — | 9 | — |
| | Pearllex DP (Nippon Paper | | | | | | |
| | Industries Co., Ltd.) | | | | | | |
| | Mw = 10000 | | | | | | |
| Naphthalene | Sodium Naphthalene Sulfonate | — | — | — | — | — | — |
| Sulfonate Salt | Demol SSL (Kao Corporation) | | | | | | |
| Metal Element | Total Metal (ppm) | 100 | 15 | 75 | 15 | 50 | 50 |
| | Ca (ppm) | 20 | 3 | 20 | 3 | — | — |
| | Mg (ppm) | 25 | 6 | 25 | 6 | 40 | 40 |
| | Mn (ppm) | 25 | 0.5 | — | — | — | — |
| | Fe (ppm) | 25 | 0.5 | 5 | 5 | 5 | 5 |
| | Al (ppm) | — | — | 12.5 | 0.5 | — | — |
| | Si (ppm) | 5 | 5 | 12.5 | 0.5 | 5 | 5 |
| Solvent | Propylene Glycol | 8 | 8 | 8 | 8 | 8 | 8 |
| | Glycerin | 8 | 8 | 8 | 8 | 8 | 8 |
| Surface | Olfine E1010 | 0.1 | 0.1 | 0.1 | 0.1 | 0.1 | 0.1 |
| Tension | | | | | | | |
| Adjuster | | | | | | | |
| Water | Pure Water | Balance | Balance | Balance | Balance | Balance | Balance |
| Ca, Mg | Alkaline Earth Metal (ppm) | 45 | 9 | 45 | 9 | 40 | 40 |
| Mn, Fe | Transition Metal (ppm) | 50 | 1 | 5 | 5 | 5 | 5 |
| Al, Si | Typical Element (ppm) | 5 | 5 | 25 | 1 | 5 | 5 |
| Evaluation | Clogging Recovery Property | B | AA | B | AA | AA | AA |
| | Color Development Property (OD) | AA | A | AA | A | AA | AA |

TABLE 3

| | | Comparative | Comparative | Comparative | Comparative |
|---|---|---|---|---|---|
| | | Example 1 | Example 2 | Example 3 | Example 4 |
| Water- | Bincho Charcoal (Pigment) | 6 | 6 | — | 6 |
| Insoluble | Carbon Black (Pigment) | — | — | — | — |
| Colorant | Dispers Red 60 (Disperse Dye) | — | — | — | — |
| Water-Soluble | Solvent Red 135 (Dye) | — | — | 6 | — |
| Colorant | | | | | |
| Lignosulfonate | Sodium Lignosulfonate | 9 | 9 | 9 | — |
| Salt | Pearllex NP (Nippon Paper | | | | |
| | Industries Co., Ltd.) | | | | |
| | Mw = 30000 | | | | |
| | Sodium Lignosulfonate | — | — | — | — |
| | Vanilex N (Nippon Paper | | | | |
| | Industries Co., Ltd.) | | | | |
| | Mw = 5000 | | | | |
| | Sodium Lignosulfonate | — | — | — | — |
| | Pearllex DP (Nippon Paper | | | | |
| | Industries Co., Ltd.) | | | | |
| | Mw = 10000 | | | | |
| Naphthalene | Sodium Naphthalene Sulfonate | — | — | — | 9 |
| Sulfonate Salt | Demol SSL (Kao Corporation) | | | | |
| Metal Element | Total Metal (ppm) | 140 | 2 | 50 | 50 |
| | Ca (ppm) | — | — | — | — |
| | Mg (ppm) | 120 | 1 | 40 | 40 |
| | Mn (ppm) | — | — | — | — |
| | Fe (ppm) | 10 | 0.5 | 5 | 5 |
| | Al (ppm) | — | — | — | — |
| | Si (ppm) | 10 | 0.5 | 5 | 5 |
| Solvent | Propylene Glycol | 8 | 8 | 8 | 8 |
| | Glycerin | 8 | 8 | 8 | 8 |
| Surface | Olfine E1010 | 0.1 | 0.1 | 0.1 | 0.1 |
| Tension | | | | | |
| Adjuster | | | | | |
| Water | Pure Water | Balance | Balance | Balance | Balance |
| Ca, Mg | Alkaline Earth Metal (ppm) | 120 | 1 | 40 | 40 |
| Mn, Fe | Transition Metal (ppm) | 10 | 0.5 | 5 | 5 |
| Al, Si | Typical Element (ppm) | 10 | 0.5 | 5 | 5 |
| Evaluation | Clogging Recovery Property | C | B | C | C |
| | Color Development Property (OD) | A | C | B | C |

### 5. Evaluation Result

As shown in Tables 1 to 3, according to Examples in each of which the ink jet ink compositions is an aqueous ink jet ink composition and contains a water-insoluble colorant, a lignosulfonate salt, and an element A selected from the group consisting of Ca, Mg, Mn, Fe, Al, and Si, and the total content of the element A is 5 to 120 mass ppm, the clogging recovery property is excellent. Hence, the ink compositions of Examples each show an excellent redispersibility.

In addition, in Examples, the color development property is evaluated as excellent. The reason for this is believed to be that the ink composition of Example has an excellent sealing effect to suppress excessive permeation of the water-insoluble colorant on the recording medium.

On the other hand, in Comparative Example 1 in which the total content of the element A is not 120 mass ppm or less, the clogging recovery property is inferior. In Comparative Example 2 in which the total content of the element A is not 5 mass ppm or more, the color development property is inferior. In Comparative Example 3 in which no water-insoluble colorant is used, the clogging recovery property is inferior. In addition, in Comparative Example 4 in which no lignosulfonate salt is used, the clogging recovery property and the color development property both are evaluated as low.

What is claimed is:

1. An aqueous ink jet ink composition comprising:
a water-insoluble colorant;
a lignosulfonate salt; and
at least one element A selected from the group consisting of Ca, Mg, Mn, Fe, Al, and Si,
wherein a total content of the element A is 5 to 120 mass ppm.

2. The ink jet ink composition according to claim 1,
wherein a total content of the Ca and the Mg is 4 to 100 mass ppm.

3. The ink jet ink composition according to claim 1,
wherein a total content of the Mn and the Fe is 1 to 50 mass ppm.

4. The ink jet ink composition according to claim 1,
wherein a total content of the Al and the Si is 25 mass ppm or less.

5. The ink jet ink composition according to claim 1,
wherein the water-insoluble colorant includes a natural-derived colorant.

6. The ink jet ink composition according to claim 1,
wherein the lignosulfonate salt includes a refined lignosulfonate salt refined using a chelating agent.

7. The ink jet ink composition according to claim 6,
wherein the chelating agent includes an aminocarboxylic acid-based chelating agent.

8. A recording method comprising:
ejecting the ink jet ink composition according to claim 1 from an ink jet head so as to be adhered to a recording medium.

9. A method for manufacturing the ink jet ink composition according to claim 1, the method comprising:
removing a complex obtained by mixing the lignosulfonate salt and a chelating agent.
